(19) United States
(12) Patent Application Publication
(10) Pub. No.: US 2018/0005324 A1
(43) Pub. Date: Jan. 4, 2018

(54) ARBITRARY BADGING IN A SOCIAL NETWORK

(71) Applicant: Quippy, Inc., San Jose, CA (US)

(72) Inventor: Alireza Jazayeri, San Jose, CA (US)

(21) Appl. No.: 15/640,299

(22) Filed: Jun. 30, 2017

Related U.S. Application Data
(60) Provisional application No. 62/356,530, filed on Jun. 30, 2016.
(60) Provisional application No. 62/356,531, filed on Jun. 30, 2016.
(60) Provisional application No. 62/356,532, filed on Jun. 30, 2016.
(60) Provisional application No. 62/356,533, filed on Jun. 30, 2016.

(51) Int. Cl. G06Q 50/00; G06Q 30/02

(52) U.S. Cl. CPC G06Q 50/01; G06Q 30/0232

(57) ABSTRACT

Aspects of invention relate to a system architecture for dynamically generating and deploying badges in a social media platform. The system includes: a computer processor; a badging module executing on the computer processor and configured to enable the computer processor to: receiving, from a badge creator, a badge definition defining a badge; identifying business logic associated with the badge definition; receiving acknowledgement of payment terms associated with delivery of the badge; receiving acknowledgement of a badge services agreement including payment terms between the badge creator and the social media platform; identifying deployment parameters of the badge including delivery time, budget, and demographic information; and deploying the badge to a set of user accounts of the social media platform based on the delivery time, budget, and demographic information, wherein deploying the badge does not require an update of a client application executing on client devices of the set of user accounts.

### CROSS-REFERENCE TO RELATED APPLICATIONS

This application claims benefit of U.S. Provisional Patent Application No. 62/356,530 (attorney docket #: quippy.00001.us.p.1), filed on Jun. 30, 2016 and entitled “CONTENT DELIVERY IN A LOCATION-BASED MESSAGING PLATFORM,” U.S. Provisional Patent Application No. 62/356,531 (attorney docket #: quippy.00001.us.p.2), filed on Jun. 30, 2016 and entitled “USER DISCOVERY IN A LOCATION-BASED MESSAGING PLATFORM,” U.S. Provisional Patent Application No. 62/356,532 (attorney docket #: quippy.00001.us.p.3), filed on Jun. 30, 2016 and entitled “ARBITRARY BADGING IN A SOCIAL NETWORK,” and U.S. Provisional Patent Application No. 62/356,533 (attorney docket #: quippy.00001.us.p.4), filed on Jun. 30, 2016 and entitled “ONSITE DISPLAY IN A LOCATION-BASED MESSAGING PLATFORM.” U.S. Provisional Patent Application Nos. 62/356,530, 62/356,531, 62/356,532, and 62/356,533 are incorporated by reference herein, in their entirety.

This application is related to the following copending U.S. Patent Applications: (1) U.S. patent application Ser. No. ______, entitled “CONTENT DELIVERY IN A LOCATION-BASED MESSAGING PLATFORM,” and filed on Jun. 30, 2017, (2) U.S. patent application Ser. No. ______, entitled “USER DISCOVERY IN A LOCATION-BASED MESSAGING PLATFORM,” and filed on June 30, 2017, and (3) U.S. patent application Ser. No. ______, entitled “ONSITE DISPLAY FOR A LOCATION-BASED MESSAGING PLATFORM,” and filed on Jun. 30, 2017. Copending U.S. patent application Ser. Nos. ______, ______, and ______ are incorporated by reference herein, in their entirety.

### BACKGROUND OF THE INVENTION

Hyperlocal and location-based social media platforms face unique challenges in identifying, aggregating, and delivering content. The majority of such platforms have historically targeted a consumer audience and have failed to generate the incentives necessary for a self-sustaining network effect. Many technical challenges associated with constraints of consumer clients and backend services have resulted in a lack of proliferation of location-based social platforms.

### BRIEF SUMMARY OF THE INVENTION

In general, in one aspect, the invention relates to a system for dynamically generating and deploying badges in a social media platform. The system includes: a computer processor; a badging module executing on the computer processor and configured to enable the computer processor to: receiving, from a badge creator, a badge definition defining a badge; identifying business logic associated with the badge definition; receiving acknowledgement of payment terms associated with delivery of the badge; receiving acknowledgement of a badge services agreement including payment terms between the badge creator and the social media platform; identifying deployment parameters of the badge including delivery time, budget, and demographic information; and deploying the badge to a set of user accounts of the social media platform based on the delivery time, budget, and demographic information, wherein deploying the badge does not require an update of a client application executing on client devices of the set of user accounts.

In general, in one aspect, the invention relates to a method for dynamically generating and deploying badges in a social media platform. The method includes: receiving, from a badge creator, a badge definition defining a badge; identifying business logic associated with the badge definition; receiving acknowledgement of payment terms associated with delivery of the badge; receiving acknowledgement of a badge services agreement including payment terms between the badge creator and the social media platform; identifying deployment parameters of the badge including delivery time, budget, and demographic information; and deploying the badge to a set of user accounts of the social media platform based on the delivery time, budget, and demographic information, wherein deploying the badge does not require an update of a client application executing on client devices of the set of user accounts.

In general, in one aspect, the invention relates to a method for providing user interface updates. The method includes: receiving, from a client device, a request to update a user interface element, the request identifying a target user interface element, a user interface media file, a category of accounts, and a requesting context account; and updating a container using the user interface media file, wherein the container corresponds to the target user interface element for the category of accounts.

Other aspects of the invention will be apparent from the following description and the appended claims.

### BRIEF DESCRIPTION OF THE DRAWINGS

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

Embodiments of the present invention are illustrated by way of example, and not by way of limitation, in the figures of the accompanying drawings and in which like reference numerals refer to similar elements.

FIGS. 1A and 1B show schematic diagrams of systems, in accordance with one or more embodiments of the invention.

FIGS. 2A-2C depict example user interfaces showing friends-only and merged (friends+nearby) streams, in accordance with one or more embodiments of the invention.

FIG. 3 depicts an example user interface displaying users nearby, in accordance with one or more embodiments of the invention.

FIGS. 4A and 4B depict example user interfaces displaying a hangout in a location-based social media stream, in accordance with one or more embodiments of the invention.

### DETAILED DESCRIPTION OF THE INVENTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

In general, embodiments of the invention provide methods and systems related to location-based social networking systems and architecture.

Arbitrary Badging

Badges generally: Apps like Waze are heavily gamified, earning badges provides incentives. Eg, for duration of app usage, reporting accidents on Waze, etc.

Badge addition/modification

It's often desirable to be able to add badges to the platform. For example, instead of a handful of standard badges across the entire platform, different users or groups may want to add their own custom badges over time (e.g., thousands of badges).

However it's a lot of work to add a new badge to the platform. Essentially need to deploy a new build of your app each time. Eg, add the image file for the badge, modify the code of every page on the client, modify the backend code, etc.

A New Approach

Arbitrary badging allows you to not have to redeploy a new version of your app to implement a new badge. For example, one implementation uses a container (where container defines the area where badges can go), and the badge image file is posted somewhere online such that the container can access the remote image file.

Users can generate the badge. A wizard user interface can be displayed to the user for displaying the badge. Early step is upload a badge that conforms to platform requirements. Select arbitrary number of recipients for the badge. Badge is pending at this point. Recipients can choose whether to accept. In order for a badge to be rolled out, a minimum threshold of users must accept the badge. So it's self-regulated. If later falls under the threshold, then the badge is disabled. Badge creator doesn't have more power than the other members. Any badge member may be able to invite others to have the badge so that the badge community could grow (e.g., if badge creator disappears). Badges generated by the social media platform provider may be different. More exclusive (can only be conferred by the social media platform provider). Could be different in color to distinguish from user created.

In one embodiment, logic is implemented that decides who and when users get a badge. The system enables users to set those rules as well.

1) User Streams: this is a repository that includes a data structure representing a stream of data for each user. This stream includes only data from friends and followed accounts initially. The Message Ingestion Service copies each message that is posted by a user into their followers/friends streams as they are posted. This is how the streams are updated in realtime as messages are “ingested” by the system. Nearby data is not added to the stream until it is requested by a user. In other words, if a user client requests their stream the Stream Generation Module fetches it from the User Streams Repo and then merges it with nearby data from the User Content Graph in realtime, then serves the merged data to the user client.

2) The clustering Engine: a distributed offline service that takes user content from the User Content Graph and groups that data into Hotspots. These hotspots, which are the output of the clustering process are stored in the Hotspots Repo.

The clustering engine begins by segmenting the clustering work geographically. Since the data in the User Content Graph is stored in a density-based geohash tree structure, the Clustering Engine can select leaf nodes of the tree (or select a fixed number of hops above the leaf nodes) in order to grab a quasi-fixed size chunk of data from a variable sized geographic region.

So some regions may be dramatically different in geographic size, but should represent some upper bound in terms of content size (i.e., number of content items).

Let's call the selected region R. The next thing that the Clustering Engine does is to grab leaf nodes of the density based geohash tree that cover the perimeter of region R.

These surrounding regions may also be of variable geographic size

Let's call the resulting region F=R (selected region)+N (neighboring regions). This resulting region F is passed to a worker service of an elastic computing cluster for analysis.

So the initial identification of the multiple F regions happens by a Master Clustering Service which then passes the F regions to multiple worker services. Each worker service performs the actual clustering on its respective region. The clustering we perform is fixed-radius clustering, but any type of clustering algorithm may be used. For example, K-means clustering or other types of clustering may be performed. Fixed radius clustering is preferred because it represents variable number of clusters of fixed (or semi-fixed) geographic size.

Once each worker completes clustering it returns the result of the clustering (a set of identified clusters) to the Master Clustering Service (MCS). The MCS the obtains the results from each worker and performs a deduplication. Deduplication means that if there are any 2 clusters that overlap, we delete the one with the lower density. Deduplication is necessary because the regions were deliberately selected to overlap, in order to prevent edge cases where a cluster overlaps two workers' regions. Since the regions overlap (by virtue of the fact that we selected perimeter neighbors), the cluster will be identified by at least 1 of the workers in full.

The MCS then stores the deduplicated results in the Hotspots Repo.

Again, the Clustering Engine includes the MCS and the workers, which are implemented in an elastic computing cluster.

The clustering engine performs the clustering and overwrites the data in the Hotspots repo periodically (eg, every 5 minutes). This way the clusters stay current and the data that is posted by users makes it into a cluster within at most 5 minutes of time (+clustering runtime).

The Hotspot Delivery module (HDM) obtains requests from clients, each request including a location of the client. The HDM then fetches a set of the hotspots from the Hotspot Repo that are closest to the client location. The Hotspots in the Hotspot Repo are also stored by their geohash value, and are also stored in a density-based geohash tree. This way, we can fetch hotspots only in the leaf node region of the tree (plus neighbors), order them by proximity to the client, and return a predefined number of them in response to the request.

3) The Social Graph Repo: this stores the relationships (both bi-directional and directed edges) between accounts. These represent followers, friends, or other types of relationships. This data is used by the Message Ingestions Service to create and store the streams (connect that edge also MIS<->Social Graph).

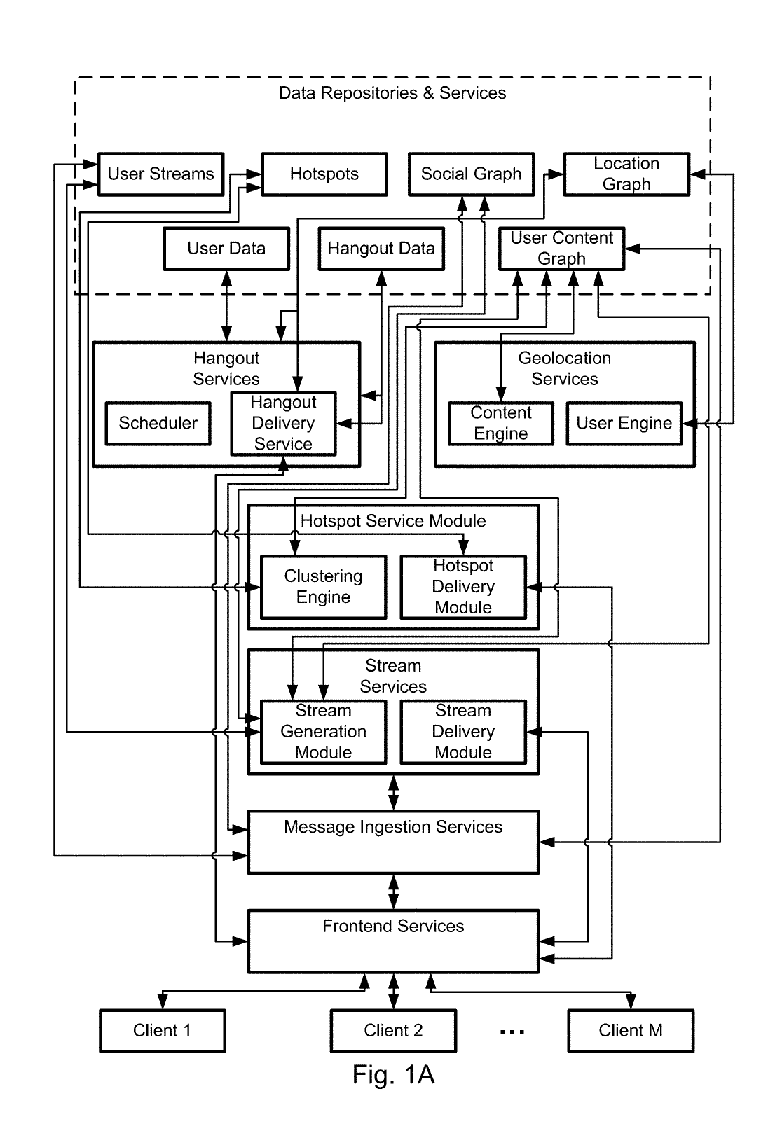

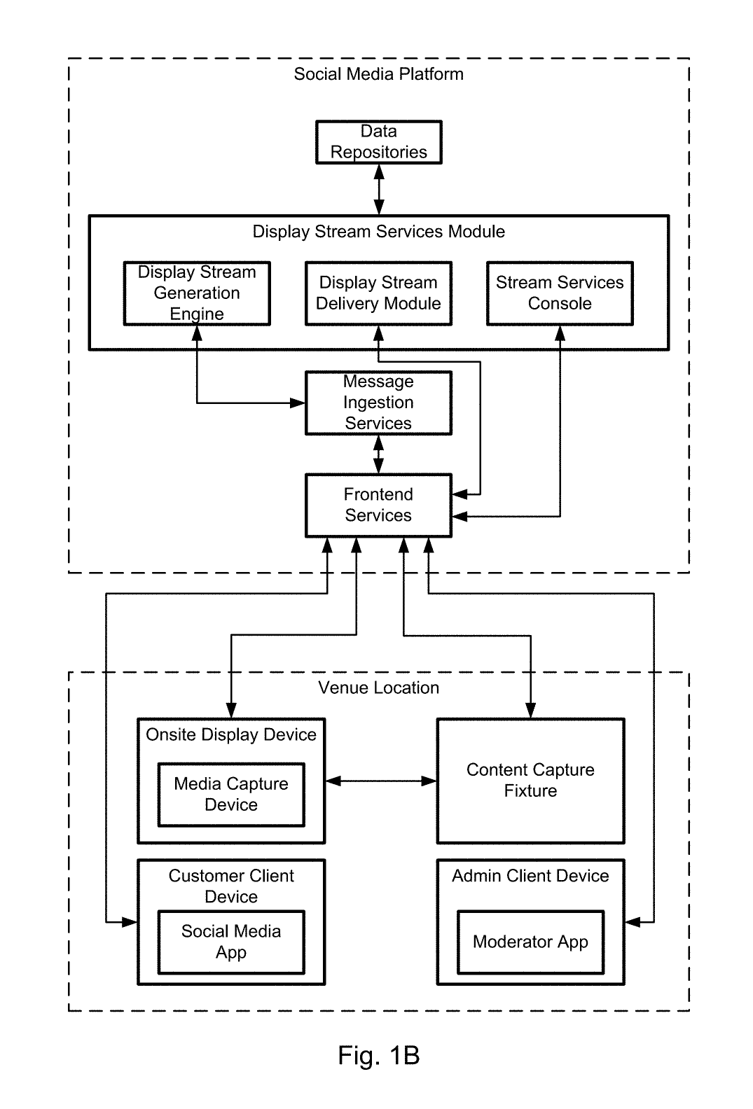

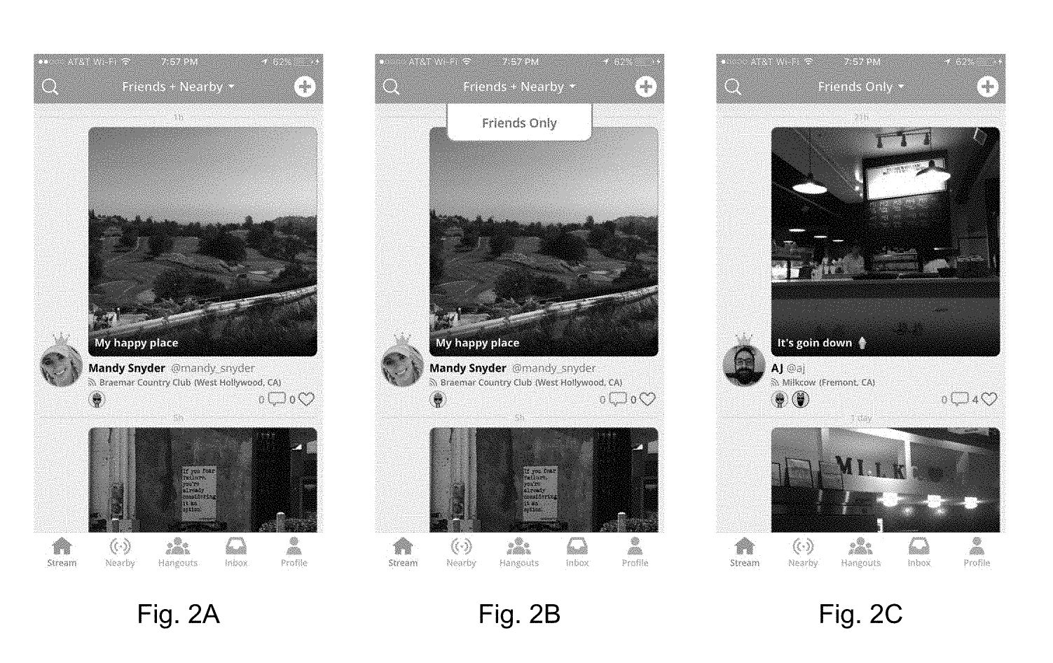

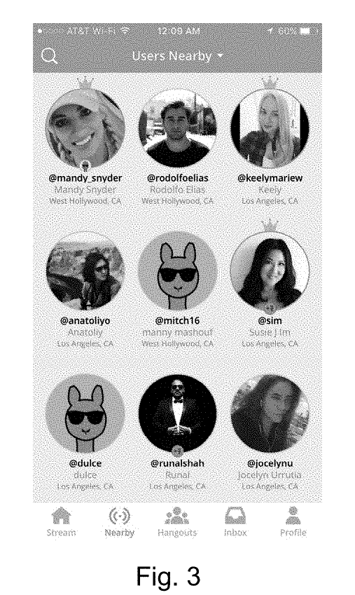

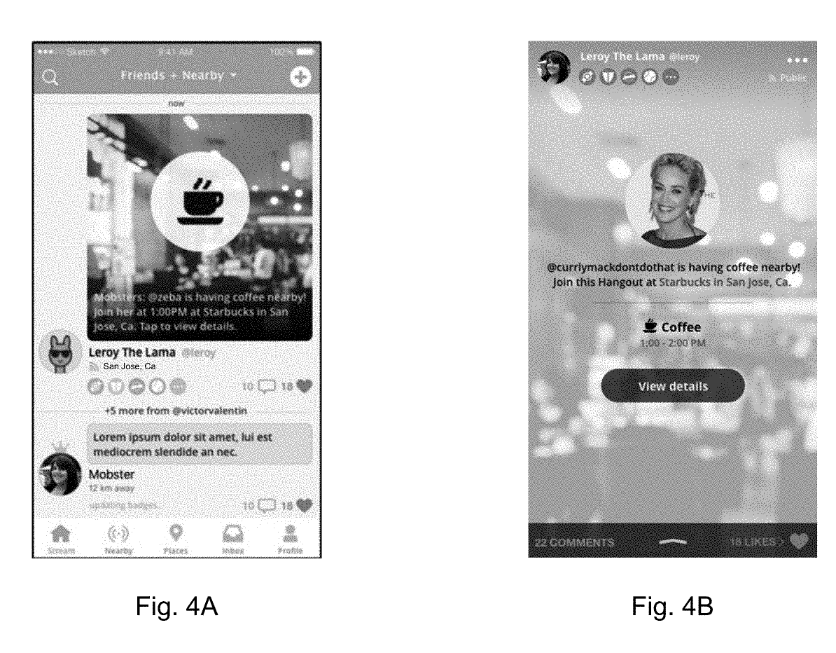

4) User Data simply stores the name, display name, and other account attributes of each user. Even though not shown, this data is used by most of the services of FIG. 1A.

5) Hangout Data Repo: this stores the details of each Hangout created by our users. Again, there may be other data repos within this repository that include necessary Hangout data.

6) Hangout Services: this is a collection of services that schedules, creates, modifies, and delivers hangouts in response to user requests. This includes a Scheduler which schedules Hangouts and generates notifications when users are invited, join, leave otherwise interact with hangouts.

Hangout Delivery Module fetches hangout information from both the Location Graph and the Hangout Data Repo and returns that data in response to client requests.

7) Location Graph Repo: this is one of the most important repositories in the system. This Repo stores objects representing the location of physical entities in a density based geohash tree structure. An object in the Location Graph can include: a user object representing the last known location of a user, a hangout object representing the location of a hangout, a venue object representing the location of a physical location (eg, a business, an event) and etc.

Each object can also include an effective date/time/duration representing when it is active. For example, once a hangout is over it would no longer be active.

Or, the timeouts for user objects would dictate how or when they are surfaced to other users (as described in the “live user discovery” algorithms).

Geolocation Services Module may periodically prune/remove stale data from the Location Graph Repo as desired.

Next topic will be how Hangout, user, and venue objects are stored in the Location Graph Repo and why that data needs to be duplicated.

So, let's start with user data in the Location Graph Repo. The Flashmob app on the user device has a background location monitoring engine (BGE) that uses the operating system API to track the user's location even when they aren't using the app. In iOS there are two methods of doing this: one is called significant location change and the other is region monitoring. Either can be used. The premise is that the BGE tracks the user's location and sends updates of the location to the Frontend Service which then relays the updates to the Geolocation Services Module. There is an object representing the user in the Location Graph Repo, and the User Engine of the Geolocation Services Module updates that user's location in the Repo. This location is stored as a geohash value. There is a Geohash Tree Engine (GTE) that is not shown, which balances all of the geohash trees and handles insertion, removal, and update of content in the tree. If the new geohash value changes from one leaf node of the density-based geohash tree to a different leaf node, the GTE performs a rebalance of the tree. The GTE performs this rebalance by basically leaving the old user object but marking it for removal (inactive) and just adding a new user object with the new geohash value. There is a periodic process which essentially “rebuilds” the geohash tree and prunes the old geohash values. In an alternate implementation, a recursive algorithm restructures the tree on-demand to maintain balance.

This maintenance of the density-based geohash tree (DBG tree), along with the GTE applies to all DBG trees in the system including the User Content Graph, and the Hotspots DBG tree in the Hotspots repo.

(although the Hotspots do not typically require insertion and removal with the exception of manual curation by and administrator, removal of NSFW content, regional blacklisting, etc)

Hangout objects in the Location Graph Repo are similarly stored. There are different consumption experiences in the client application that require different usages of this Repo. The main ones are: Nearby User Discovery, Hangouts Discovery, Venue Discovery, and hybrids of one or more of them. The term “live user discovery” can refer to any of the aforementioned and is not strictly limited to user objects. So, in nearby user discovery for example, the Geolocation Services Module gets a request to fetch nearby users for a client. The location of the client is used to identify a search region R (including perimeter neighbors), all active users in R are ordered by proximity to the client, and the closest X users (depending on requested page size) are returned to the client in response to the client request.

In the hybrid approach, a single view in the client application can display any of the three object types in the same result set, ordered by proximity to the client.

One important point about the DBG trees is that they include replicated data (for performance reasons). In other words, each DBG tree node includes all data required for its respective consumption experience. For example, user objects include username, display name, profile thumbnail URL, and a subset of other user attribute data that is already stored in the User Data Repo. Updates to the User Data Repo must therefore also be made to the Location Graph Repo and vice versa to maintain consistency. In this way, a single query to the Location Graph Repo can quickly fetch results with no external dependency.

For purposes of this disclosure, the terms messaging platform, social media platform, and social network may be used interchangeably.

Various system configurations: Although the components of the systems are depicted as being directly communicatively coupled to one another, this is not necessarily the case. For example, one or more of the components of the systems may be communicatively coupled via a distributed computing system, a cloud computing system, or a networked computer system communicating via the Internet.

Various system configurations: It should be appreciated that one computer system may represent many computer systems, arranged in a central or distributed fashion. For example, such computer systems may be organized as a central cloud and/or may be distributed geographically or logically to edges of a system such as a content delivery network or other arrangement. It is understood that virtually any number of intermediary networking devices, such as switches, routers, servers, etc., may be used to facilitate communication.

While the present disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. Some of the steps may be performed simultaneously. For example, in certain circumstances, multitasking and parallel processing may be advantageous. The various example methods described and/or illustrated herein may also omit one or more of the steps described or illustrated herein or include additional steps in addition to those disclosed.

Embodiments may be implemented on a specialized computer system. The specialized computing system can include one or more modified mobile devices (e.g., laptop computer, smart phone, personal digital assistant, tablet computer, or other mobile device), desktop computers, servers, blades in a server chassis, or any other type of computing device(s) that include at least the minimum processing power, memory, and input and output device(s) to perform one or more embodiments.

For example, a computing system may include one or more computer processor(s), associated memory (e.g., random access memory (RAM), cache memory, flash memory, etc.), one or more storage device(s) (e.g., a hard disk, an optical drive such as a compact disk (CD) drive or digital versatile disk (DVD) drive, a flash memory stick, etc.), a bus, and numerous other elements and functionalities. The computer processor(s) may be an integrated circuit for processing instructions. For example, the computer processor(s) may be one or more cores or micro-cores of a processor.

In one or more embodiments, the computer processor(s) may be an integrated circuit for processing instructions. For example, the computer processor(s) may be one or more cores or micro-cores of a processor. The computer processor(s) can implement/execute software modules stored by computing system, such as module(s) stored in memory or module(s) stored in storage. For example, one or more of the modules described in the figures can be stored in memory or storage, where they can be accessed and processed by the computer processor. In one or more embodiments, the computer processor(s) can be a special-purpose processor where software instructions are incorporated into the actual processor design.

The computing system may also include one or more input device(s), such as a touchscreen, keyboard, mouse, microphone, touchpad, electronic pen, or any other type of input device. Further, the computing system may include one or more output device(s), such as a screen (e.g., a liquid crystal display (LCD), a plasma display, touchscreen, cathode ray tube (CRT) monitor, projector, or other display device), a printer, external storage, or any other output device. The computing system may be connected to a network (e.g., a local area network (LAN), a wide area network (WAN) such as the Internet, mobile network, or any other type of network) via a network interface connection. The input and output device(s) may be locally or remotely connected (e.g., via the network) to the computer processor(s), memory, and storage device(s).

One or more elements of the aforementioned computing system may be located at a remote location and connected to the other elements over a network. Further, embodiments may be implemented on a distributed system having a plurality of nodes, where each portion may be located on a subset of nodes within the distributed system. In one embodiment, the node corresponds to a distinct computing device. Alternatively, the node may correspond to a computer processor with associated physical memory. The node may alternatively correspond to a computer processor or micro-core of a computer processor with shared memory and/or resources.

For example, one or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface.

One or more elements of the above-described systems may also be implemented using software modules that perform certain tasks. These software modules may include script, batch, routines, programs, objects, components, data structures, or other executable files that may be stored on a computer-readable storage medium or in a computing system. These software modules may configure a computing system to perform one or more of the example embodiments disclosed herein. The functionality of the software modules may be combined or distributed as desired in various embodiments. The computer readable program code can be stored, temporarily or permanently, on one or more non-transitory computer readable storage media. The non-transitory computer readable storage media are executable by one or more computer processors to perform the functionality of one or more components of the above-described systems and/or flowcharts. Examples of non-transitory computer-readable media can include, but are not limited to, compact discs (CDs), flash memory, solid state drives, random access memory (RAM), read only memory (ROM), electrically erasable programmable ROM (EEPROM), digital versatile disks (DVDs) or other optical storage, and any other computer-readable media excluding transitory, propagating signals.

It is understood that a “set” can include one or more elements. It is also understood that a “subset” of the set may be a set of which all the elements are contained in the set. In other words, the subset can include fewer elements than the set or all the elements of the set (i.e., the subset can be the same as the set).

While the invention has been described with respect to a limited number of embodiments, those skilled in the art, having benefit of this disclosure, will appreciate that other embodiments may be devised that do not depart from the scope of the invention as disclosed herein.

What is claimed is:

1. A system for dynamically generating and deploying badges in a social media platform, comprising:
a computer processor;
a badging module executing on the computer processor and configured to enable the computer processor to:
receiving, from a badge creator, a badge definition defining a badge;
identifying business logic associated with the badge definition;
receiving acknowledgement of payment terms associated with delivery of the badge;
receiving acknowledgement of a badge services agreement including payment terms between the badge creator and the social media platform;
identifying deployment parameters of the badge including delivery time, budget, and demographic information; and
deploying the badge to a set of user accounts of the social media platform based on the delivery time, budget, and demographic information, wherein deploying the badge does not require an update of a client application executing on client devices of the set of user accounts.

2. The system of claim 1, wherein the badge creator is an owner of an account of the social media platform.

3. The system of claim 1, wherein the badge is a user profile attribute displayable concurrently with user accounts of the social media platform.

4. The system of claim 1, wherein the business logic comprises utilizing the badge for participants of a customer loyalty program of the badge creator.

5. The system of claim 1, further comprising an administrative console module operable to provide an administrative console user interface, wherein the administrative console user interface allows an administrator to assign the badge to the set of users.

6. The system of claim 1, further comprising an administrative console module operable to provide an administrative console user interface, wherein the administrative console user interface allows an administrator to define rules/conditions, which when met, programmatically assign the badge to the set of user accounts.

7. The system of claim 1, wherein the badging module is further configured to enable the computer processor to receive a request by a user account to create a badge, to be deployed a badge, or to nominate another user account for badge deployment.

8. A method for dynamically generating and deploying badges in a social media platform, comprising:
receiving, from a badge creator, a badge definition defining a badge;
identifying business logic associated with the badge definition;
receiving acknowledgement of payment terms associated with delivery of the badge;
receiving acknowledgement of a badge services agreement including payment terms between the badge creator and the social media platform;
identifying deployment parameters of the badge including delivery time, budget, and demographic information; and
deploying the badge to a set of user accounts of the social media platform based on the delivery time, budget, and demographic information, wherein deploying the badge does not require an update of a client application executing on client devices of the set of user accounts.

9. The method of claim 8, wherein the badge creator is an owner of an account of the social media platform.

10. The method of claim 8, wherein the badge is a user profile attribute displayable concurrently with user accounts of the social media platform.

11. The method of claim 8, wherein the business logic comprises utilizing the badge for participants of a customer loyalty program of the badge creator.

12. The method of claim 8, further comprising an administrative console module operable to provide an administrative console user interface, wherein the administrative console user interface allows an administrator to assign the badge to the set of users.

13. The method of claim 8, further comprising an administrative console module operable to provide an administrative console user interface, wherein the administrative console user interface allows an administrator to define rules/conditions, which when met, programmatically assign the badge to the set of user accounts.

14. A method for providing user interface updates, comprising:
receiving, from a client device, a request to update a user interface element, the request identifying a target user interface element, a user interface media file, a category of accounts, and a requesting context account; and
updating a container using the user interface media file, wherein the container corresponds to the target user interface element for the category of accounts.

15. The method of claim 14, wherein the user interface media file comprises at least one selected from a group consisting of an image file, an audio file, and a video file.

16. The method of claim 8, further comprising:
querying a set of accounts corresponding to the category for approval of updating the target user interface element; and
upon determining that a count of approvals exceeds a threshold, updating the target user interface element with the media file for the approving accounts.

17. The method of claim 16, further comprising:
upon determining that the count of approvals has fallen below the threshold, updating the target user interface element to no longer use the media file for any accounts.
